(19) United States
(12) Patent Application Publication
(10) Pub. No.: US 2018/0281345 A1
(43) Pub. Date: Oct. 4, 2018

(54) Method for Manufacturing a Welded Component and Use of the Component

(71) Applicant: Outokumpu Oyj, Helsinki (FI)

(72) Inventors: Thomas Fröhlich, Ratingen (DE); Stefan Lindner, Willich (DE)

(21) Appl. No.: 15/764,540

(22) PCT Filed: Oct. 4, 2016
(86) PCT No.: PCT/EP2016/073654

§ 371 Date: Mar. 29, 2018

(30) Foreign Application Priority Data
Oct. 5, 2015 (EP) 15188317.0

(51) Int. Cl. B32B 7/04; B32B 3/26; B32B 3/30; B32B 15/04; B32B 37/06; B23P 17/04

(52) U.S. Cl. CPC B32B 7/045; B32B 3/266; B32B 3/30; B32B 15/04; B23P 2700/50; B23P 17/04; B32B 2605/00; B23P 2700/01; B32B 37/06

(57) ABSTRACT

The invention relates to a method for manufacturing a welded component, where at least one material piece is positioned between metal pieces to be welded together. At least one protrusion (5, 13, 23, 33, 43) is achieved to at least one of the metal pieces (3, 4; 11, 12; 21, 22; 31, 32; 41, 42) to be welded together, and at least one opening (2, 14, 24, 34, 44) is achieved to at least one material piece (1, 15, 25, 35, 45) which is positioned between the metal pieces (3, 4; 11, 12; 21, 22; 31, 32; 41, 42) to be welded and isolated (16, 17; 26; 36) from the metal pieces to be welded. At least one part of the protrusion (5, 13, 23, 33, 43) in one of those metal pieces to be welded together is taken through the opening (2, 14, 24, 34, 44) in order to have mechanical contact through the upper end of the protrusion (5, 13, 23, 33, 43) with the second metal piece to be welded. Welding (37, 38, 39) of the metal pieces together is carried out by focusing the weld effect to the surface of the second metal piece which is in connection with the protrusion to the first metal piece to be welded. The invention also relates to the use of the component.

The present invention relates to a method for manufacturing a component by welding metal pieces together so that there is positioned at least one material piece between the metal pieces to be welded together. The invention also relates to the use of the component.

A material construction, which contains at least two different materials fastened to each other, becomes more and more important for transport manufacturing areas like automotive, commercial vehicles, buses or railway vehicles. The so-called “multi-material-design” wants to apply every time the right material to the right place. But the conventional joining methods reach their limits in point of dissimilar joining combinations like steel to aluminium or steel to carbon fiber. One other problem is the different corrosion potentials of the used materials.

When there is a direct contact between the sheets or elements, corrosion will attack the ignobly material. The problem will be so much worse when there are wet areas or solutions, like chlorides.

The GB patent 1363536 describes a structural panel with a thickness dimension greater than the sum of the thickness of the panels employed in the combination using a numerous tabs perforated from the panel planes with all tabs standing to the plane of the panel sheet. Further, the tabs can be attached to one another so that a tight adjoinment exists between an intermediate tab pair extending between the two sheets. The GB patent 1363536 shows a perpendicular position of the tab to the panel sheet as well as a tab pair formed in connection with the perforations in order to strengthen the panel. In the structure only two panel layers are connected to each other.

The object of the present invention is to eliminate drawbacks of the prior art and to achieve a method for manufacturing a welded component where at least one material piece is positioned between metal pieces to be welded together. The object of the invention is also the use of the component. The essential features of the present invention are enlisted in the appended claims.

According to the present invention at least one protrusion is achieved to at least one of the metal pieces to be welded together. At least one opening is achieved to at least one material piece to be positioned between the metal pieces to be welded so that at least one part of the protrusion in one of the metal pieces to be welded together is taken through the opening. Thus mechanical contact through the upper end of the protrusion with the second metal piece to be welded is achieved. Welding of the metal pieces together is carried out by focusing the weld effect to the surface of the second metal piece which is in connection with the protrusion to the first metal piece to be welded.

In a component manufactured according to the invention at least one of the metal pieces to be welded together is thus provided with at least one protrusion in order to have mechanical contact through the upper end of the protrusion with the second metal piece to be welded. When describing the invention with the term “first metal piece” it is meant the metal piece with the protrusion and with the term “second metal piece” the opposite metal piece whereto the upper end of the protrusion has a mechanical contact. When describing the invention with the term “the upper end of the protrusion” it is meant the end of the protrusion which is opposite to the end of the protrusion fixed with one metal piece before welding. In one embodiment of the invention, both the metal pieces are provided with protrusions in such a manner that the protrusion in one of those metal pieces is not opposite with the protrusion in the opposite metal piece.

A material piece provided with at least one opening will be positioned as an interlayer between the metal pieces to be welded. The opening of the material piece is shaped so that at least one part of the protrusion in one of those metal pieces to be welded together is taken through the opening. The protrusion is positioned to the opening so that any direct contact between the protrusion and the opening is prevented. The part of the protrusion which has been taken through the opening is then mechanically in connection with the surface of the second metal piece to be welded. When the metal pieces are thus positioned to each other, welding according to the invention is carried out by focusing the weld effect to the surface of the metal piece which has contact with the protrusion of the metal piece to be welded. Thus, it is achieved a stacked welded component, consisting of at least one material piece positioned between the welded metal pieces.

According to the invention it is possible to join material combinations which are directly unweldable together and which consists of at least three parts, because the method of the invention makes possible to join two materials as a three part component without direct contact to each other. The material piece with the openings is thus joint as a form closure method or as a form fit connection method to the other sheets, against which the metal pieces to be welded has a material connection to each other Thus, different electrochemical potential for corrosion between the interlayer material and the welded metal pieces is not relevant for the component manufactured with the method of the invention.

The metal pieces to be welded together in accordance with the invention are made of coated steel, stainless steel, aluminium, magnesium, copper or brass. The metal pieces are made of similar material, or the metal pieces are made of materials forming a material combination, which is weldable together. The welding of the metal pieces together is carried out by thermal joining processes such as resistance welding processes, TIG-spot welding or beam welding processes such as laser beam welding or electron beam welding. At least one of the metal pieces to be welded together is provided with at least one protrusion in which case the metal piece is at least partly three-dimensional. The protrusion has a shape of a cone, a pin, a taper or any other geometry which is useful for achieving a mechanical contact with the other metal piece to be welded. Advantageously, the metal piece is provided with several protrusions which are manufactured by a forming process such as injection, clinching, spiring, expanding or hydroforming.

The material piece positioned as an interlayer between the metal pieces to be welded is made of metal-based material, such as coated steel, stainless steel, aluminium, magnesium, copper or brass or it is made of a fiber composite or a cement plate. The interlayer is provided at least one opening which is positioned to the protrusion of the metal piece so that at least a part of the protrusion can be taken through the opening so that any mechanical contact with the interlayer material is prevented. Advantageously, an interlayer has several openings which can be made by perforating the interlayer. The perforation of the interlayer can be manufactured by stamping, punching, boring, cutting or thermal cutting such as laser beam or plasma jet and plasma beam.

According to the invention the metal piece with the protrusions is stacked into the openings of the interlayer. The area of the openings in the interlayer is so shaped that at least one part of the protrusions is taken through the opening in a manner that there is no contact between the interlayer, the protrusions and the metal pieces during and after stacking. In order to prevent the contact between the interlayer and the protrusion before stacking a layer of an isolating material is distributed on the surface of the interlayer. The isolating material is a polymer, fluidity adhesive, a bonding tape, a tape with impregnated fleece material, plastic isolating material or ceramic material. The isolating material avoids the risk of electrochemical insulation, galvanic and contact corrosion between the metal pieces to be welded and the interlayer material. During stacking the interlayer is form-locked and joined because of the position between the openings and protrusions. After stacking and welding of the metal pieces together the interlayer is pressed in a desired manner between the metal pieces in order to have a welded component.

The component manufactured by the method of the invention is used as a connection part or a joining area to join cross members, longitudinal members, front walls, pillars, floor assemblies or a channel to each other for a passenger car, for example as a connection between a b-pillar and a rocker rail. The component can also be used as a connection part or a joining area to join side walls, floor panels, roof or step plates to each other for railway vehicle cars, for example as a connection between a floor plate and a side wall. Further, the component can be used as a connection part or a joining area to join sheets, plates, tubes or profiles for agricultural machines, buses or trucks as well as to join plates and sheets in aerospace or space flight solutions, for example as a connection between a floor plate and a side wall. The component is also useful for building construction, for example as a connection between a building shell and face elements, and for bridge and building construction, for example as an alternative material for reinforced concrete.

Using the component manufactured by the method of the invention it is possible to create a semi-finished product, such as a sandwich sheet, and/or a tailored part. Further the component manufactured by the method of the invention can be utilized as an adaptation member to be connected to at least one other component.

The present invention is described in more details referring to the drawings, wherein

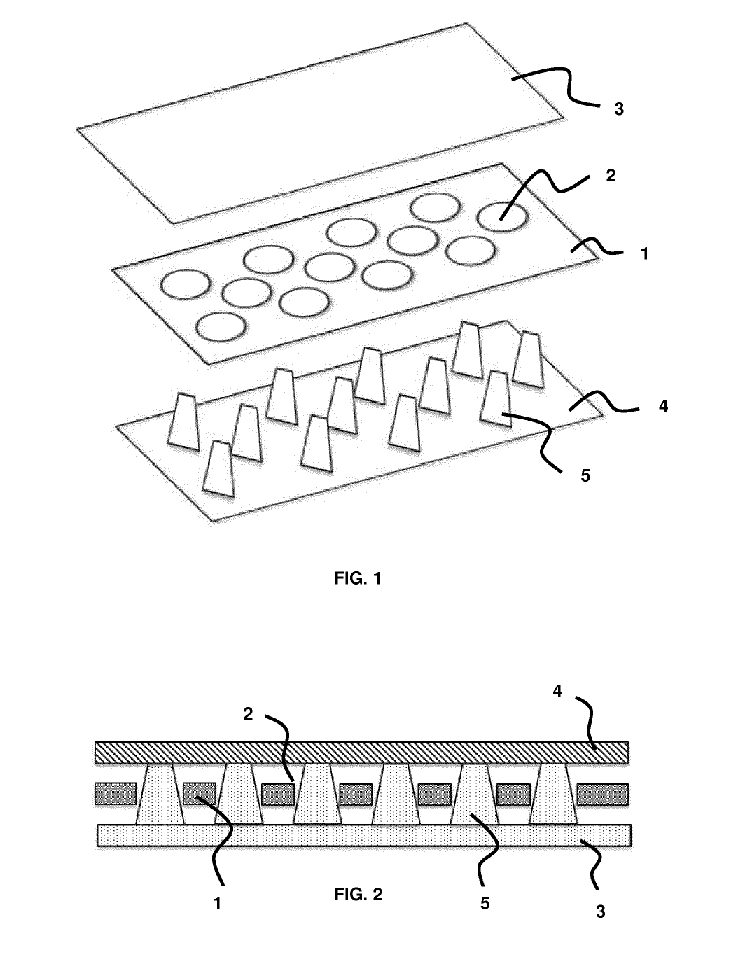

FIG. 1 shows one preferred embodiment of the invention schematically as an a axonometric projection seen on a slant position from above before stacking,

FIG. 2 shows the embodiment of FIG. 1 schematically as a side view after stacking and welding,

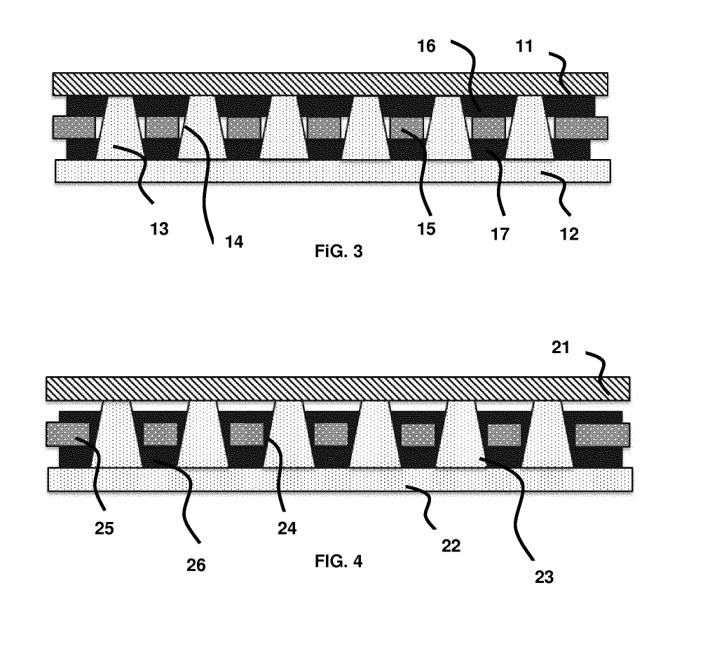

FIG. 3 shows one preferred embodiment of the invention schematically as a cut side view after stacking,

FIG. 4 shows one preferred embodiment of the invention schematically as a cut side view after stacking,

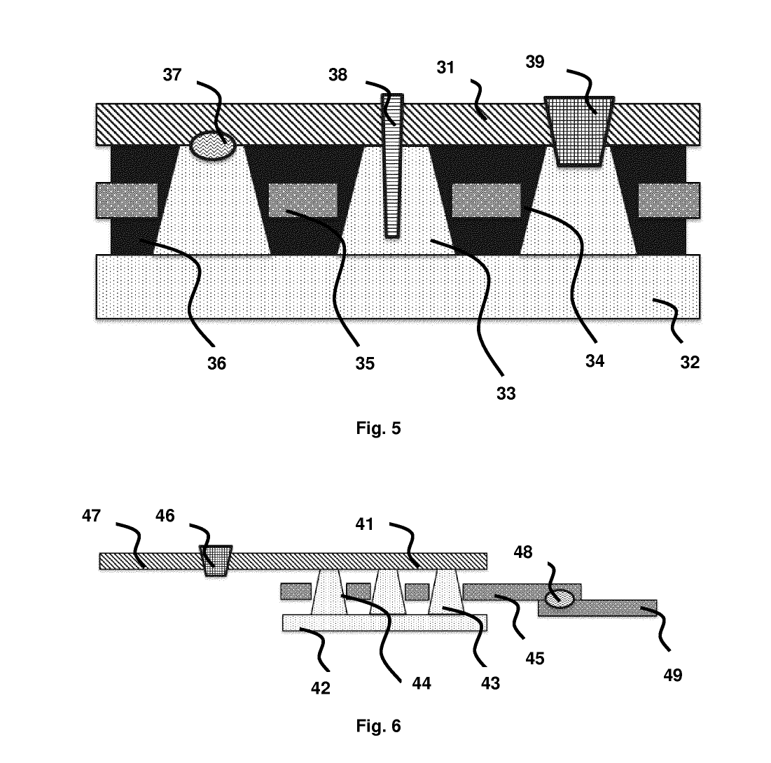

FIG. 5 shows one preferred embodiment of the invention schematically as a cut side view after stacking and welding, and

FIG. 6 shows one preferred embodiment of the invention schematically as a cut side view after stacking and welding.

In FIG. 1 an interlayer sheet 1 is provided with holes 2, and the interlayer 1 is positioned between two metal sheets 3 and 4. The metal sheet 3 is structured so that protrusions 5 are shaped on the surface of the metal sheet 3.

In FIG. 2 the metal sheets 3 and 4 are stacked so that the protrusions 5 are partly taken through the holes 3 of the interlayer 1. The metal sheets 3 and 4 have mechanical contacts 6 through upper ends 7 of the protrusions 5. An isolating material achieving isolation between the interlayer 1 and the metal sheets 3 and 4 is not shown.

In FIG. 3 the metal sheets 11 and 12 are stacked so that the protrusions 13 are partly taken through the holes 14 in the interlayer 15. The interlayer 15 is supported with two isolating materials 16 and 17 in order to prevent any mechanical contact between the protrusions 13 and the interlayer 15.

In FIG. 4 the metal sheets 21 and 22 are stacked so that the protrusions 23 are partly taken through the holes 24 in the interlayer 25. The interlayer 25 is supported with one isolating material 26 in order to prevent any mechanical contact between the protrusions 23 and the interlayer 25.

In FIG. 5 the metal sheets 31 and 32 are stacked so that the protrusions 33 are partly taken through the holes in the interlayer 35. The interlayer 35 is supported with one isolating material 36 in order to prevent any mechanical contact between the protrusions 33 and the interlayer 35. FIG. 5 also illustrates alternatives for welding of the metal sheets 31 and 32 together; a weld nugget 37 generated by a resistance spot weld, a weld seam 38 generated by a laser beam process and a weld seam 39 generated by a TIG spot welding process.

In FIG. 6 the metal sheets 41 and 42 are stacked so that the protrusions 43 are partly taken through the holes 44 in the interlayer 45. Any isolating material is not shown. In order to manufacture a tailored product from the component of the invention the metal sheet 41 has a joint 46 to another component 47, and the interlayer 46 has a joint 48 with an interlayer material 49 separated from the interlayer 45 of the component of the invention.

1. A method for manufacturing a welded component, where at least one material piece is positioned between metal pieces to be welded together, wherein at least one protrusion present on at least one first metal piece to be welded together, and at least one opening is present in at least one material piece which is positioned between the metal pieces to be welded and isolated from the metal pieces to be welded so that at least one part of the protrusion in at least one first metal piece to be welded together extends through the opening in order to have mechanical contact between an upper end of the protrusion and a second metal piece to be welded, and welding of the metal pieces together is carried out by focusing the weld effect on a surface of the second metal piece which is in contact with the protrusion of the first metal piece to be welded.

2. The method according to claim 1, wherein the protrusion is manufactured by a forming process selected from the group consisting of injection, clinching, spiring, expanding or hydroforming.

3. The method according to claim 1, wherein the opening in the material piece is manufactured by stamping, punching, boring, cutting, thermal cutting, laser beam, plasma jet, or plasma beam.

4. The method according to claim 1, wherein the welding of the metal pieces together is carried out by a thermal joining process selected from the group consisting of resistance welding and TIG-spot welding or by a beam welding process selected from the group consisting of laser beam welding and electron beam welding.

5. The method according to claim 1, wherein isolating material is distributed on a surface of the at least one material piece in order to prevent contact between the material piece and the protrusion.

6. The method according to claim 5, wherein the isolating material is selected from the group consisting of a polymer, fluidity adhesive, a bonding tape, a tape with impregnated fleece material, plastic isolating material and ceramic material.

7. The method according to claim 1, wherein the metal pieces to be welded together are made of coated steel, stainless steel, aluminium, magnesium, copper or brass.

8. The method according to claim 1, wherein the material piece is made of a metal-based material.

9. The method according to claim 1, wherein the protrusion is shaped as a cone, a pin, a taper or any other geometry useful for achieving a mechanical contact with the other metal piece to be welded.

10. Use of the component manufactured according to the method of claim 1 as a connection part or as a joining area in a passenger car.

11. Use of the component manufactured according to the method of claim 1 as a connection part or as a joining area in a railway vehicle car.

12. Use of the component manufactured according to the method of claim 1 as a connection part or as a joining area in an agricultural machine.

13. Use of the component manufactured according to the method of claim 1 as a connection part or as a joining area in a bus or in a truck.

14. Use of the component manufactured according to the method of claim 1 as a connection part or as a joining area in aerospace solutions.

15. Use of the component manufactured according to the method of claim 1 as a connection part or as a joining area in a space flight solutions.

16. Use of the component manufactured according to the method of claim 1 as an adaptation member to be connected to at least one other component.

17. The method according to claim 8, wherein the metal-based material is selected from the group consisting of coated steel, stainless steel, aluminium, magnesium, copper or brass, a fiber composite or a cement plate or a ceramic material.
